(19) United States
(12) Patent Application Publication
(10) Pub. No.: US 2002/0043799 A1
(43) Pub. Date: Apr. 18, 2002

(54) NOVEL TELEVISION PROGRAMMING GUIDE

(75) Inventor: RICHARD WILEN, ISLANDIA, NY (US)

Correspondence Address: STEPHEN E FELDMAN, 12 EAST 41ST STREET, SUITE 1302, NEW YORK, NY, 10017

(73) Assignee: wilen

(21) Appl. No.: 08/855,603

(22) Filed: May 13, 1997

(51) Int. Cl. B42D 15/00

(52) U.S. Cl. 283/67

(57) ABSTRACT

The instant invention provides an improved television program guide and a method of making it. The guide includes: a front cover; a back cover; and, at least n substantially rectangular pages between the front cover and the back cover; wherein n is a finite integer; wherein the first of the n pages is most proximate the front cover and the nth of the n pages is more proximate the back cover than the first page; wherein the lateral dimension of the nth page is larger than the lateral dimension of the (n-1)th page; and, wherein an area on the nth page is in view when the guide is opened to the (n-1)th page.

### BACKGROUND OF THE INVENTION

This invention relates to novel television programming guide which substantially reduces the time it would otherwise take to determine the general contents of a page therein, and has particular utility for use as an aid to the viewer with a specific viewing interest who has a television receiver having a large number of available television channels. The invention broadly relates to a novel television programming guide, wherein by merely opening the front cover of the guide, the television viewer is presented with a view of at least a portion of more than one page of the guide. More specifically, the instant invention relates to a novel television programming guide, wherein by merely opening the front cover of the guide, the television viewer is presented with a view of at least a portion of more than one page of the guide, optionally wherein, graphic and printed indicia on each portion optionally indicates the printed contents of at least one of each page therein.

Television program guides and methods of making them are well known in the prior art:

U.S. Pat. No. 5,407,233, entitled: “Magazine assembly,” issued to Wilen, teaches a process wherein a paper from a roll or other supply is processed by an in-line magazine publishing and/or assembly system. A magazine (typically a television programming guide) with a cover made from two sheets of paper is produced. The cover is assembled from two sheets, one of which has a pattern of adhesive material printed on one sheet, the second sheet being placed over the first sheet forming a two sheet cover. One sheet has a pattern of perforations and pattern of slits cut in its surface. The pattern of perforations and pattern of slits and part of the pattern of adhesive material combine to form a tear-out portion in the cover. The tear-out portion may be an envelope or an invoice or an order blank. More specifically, the invention teaches a magazine having a front cover, a back cover and a plurality of pages on which magazine indicia is imprinted, the plurality of pages secured between the front cover and the back cover which includes: a) a first sheet of material from which the magazine is formed, a first predetermined line extending along a length of the first sheet for defining a first part of the first sheet and a second part of the first sheet, the first part separated from the second part along the first predetermined line, the second part including the magazine indicia imprinted thereon and the second part folded for defining at least a first page and a second page of the plurality of pages; b) a second predetermined line extending along a length of the first part of the first sheet for defining a first fold line on the first part of the first sheet, the first part being folded over itself along the first fold line for forming a two-ply sheet; c) a pattern of lines of adhesive material applied to the first part of the first sheet for bonding the first part to itself when the first part is folded over itself on the first fold line for forming the two-ply sheet, the two-ply sheet having an inside sheet and an outside sheet; d) a second fold line extending along a width of the two-ply sheet for defining the front cover of the magazine and the back cover of the magazine; and e) the first page and the second page positioned on the inside sheet, on the second fold line, and secured to the inside sheet of the two-ply sheet, along the second fold line, for securing the first page and the second page of the plurality of pages between the front cover and the back cover when the two-ply sheet is folded along the second fold line.

U.S. Pat. No. 5,217,259, entitled: “Television programming apparatus,” issued to Wilen, teaches a multi-sheet overlay is placed over a basic television programs listing. Two of the sheets of the overlay are removably adhered together, one sheet being a transparent sheet and the other being a non-transparent sheet. The non-transparent sheet is selectively kiss-cut so that select sections of the non-transparent sheet may be removed to expose corresponding sections of the transparent sheet and reveal selected sections of the television programs listing. Data is printed on a sheet of the overlay relating to a television system the differs from the basic television listing. By selectively removing kiss-cut sections on the overlay, multiple bits of data may be combined to provide a television programs listing for a television system differing from the system represented in the basic television programs listing.

U.S. Pat. No. 5,015,319, entitled: “Programmable rack and system for making same,” issued to Wilen, teaches an in-line processing system for processing a supply of paper into a disposable programmable rack or organizer is provided. The processing system may be integrated into a publishing or assembly system for making a magazine or other booklet (typically a television programming guide) from a paper supply. Paper is processed into a programmable organizer by laying down a pattern of adhesive stripes on the surface of the paper and by cutting a pattern of slits in the paper and then folding the paper over itself forming a two-ply sheet held together by the adhesive stripes and defining longitudinal pockets across the two-ply sheet. The pattern of slits form openings in the pockets. A programmable rack may be made as a unit or may be integrated into a magazine.

U.S. Pat. No. 4,824,503, entitled: “Magazine assembly system and method,” issued to Wilen, teaches paper from a roll or other supply which is processed by an in-line magazine publishing and/or assembly system. The processing sequence includes printing pages of the magazine (typically a television programming guide) in predetermined places on the paper, laying down patterns of glue in other places of the paper, cutting a pattern of perforations and slits in the paper related to the glue pattern, cutting the paper into two sections, one of which is folded forming the pages of the magazine. The other section is folded forming the magazine cover, including pockets defined by the glue pattern. One pocket takes the form of a tear-out remittance envelope, the other pocket taking the form of a tear-out invoice sheet. A window in the cover exposes and uses the name and address on the invoice for the magazine mailing address.

U.S. Pat. No. 5,214,869, to Wilen, entitled: “Programmable organizer and method of making same,” teaches a disposable two-ply programmable rack or organizer, along with a preferred in-line paper supply handling or manufacturing system. A preferred system, using a roll of paper for a supply source is shown and described along with several alternate systems. Paper of the supply may be pre-printed or blank so that the two-ply programmable rack or organizer may be manufactured in printed form or made in blank form.

U.S. Pat. No. 4,815,225, to Wilen, entitled: “Programming device,” teaches a calender period which is set out on one sheet which faces a second sheet. The same calender period is set out on the second sheet but in mirror image to the first sheet. A transparent sheet is disposed between the sheets and is adapted to overlay one sheet or the second sheet. The transparent sheet includes storage pockets corresponding with the calender period set out on the sheets. Data or information placed on both sides of a data or information carrying sheet may then be associated with the same calender date by flipping the transparent sheet from one calender page to the other calender page. More specifically, the invention teaches an organizer for storing and retaining cards and/or stamps containing data on it and includes: (a) a plurality of sheets, each sheet having substantially the same width dimension, defined by opposite edges and having first and second ends, the length of each sheet being substantially the same and each length defined by respective first and second ends of the respective sheet; (b) each sheet of the plurality of sheets positioned with a face thereof adjacent a face of another sheet of the plurality; (c.) the first ends of adjacent sheets being offset from each other a predetermined distance; and (d) the plurality of sheets folded at a common fold so that one sheet of the plurality is folded over itself face-to-face so that the first end of the one sheet is offset from the second end of the one sheet the predetermined distance for forming a plurality of pockets across the width of the sheet and defined by the first ends and the second ends.

Moreover, optimum television viewing pleasure for a viewer with specialized interests and tastes requires rapid access to television scheduling information on such interests and tastes. However, at present, the only source for television scheduling information is the typical television program schedule guide. Unfortunately for the viewer with specialized interests and tastes, all television program schedule guides are compiled to provide a chronological sequence of television programs drawn to diverse interests and tastes. With the advent of a myriad of stations available through cable and satellite systems, the avid viewer must often sacrifice precious viewing time by searching for his favorite television programs either by wading through a myriad of printed material or by “channel surfing.” Thus, there presently exists a long felt need for a television program schedule guide which reduced the time required for the avid viewer to locate information regarding the scheduling of his favored programming.

### SUMMARY OF THE INVENTION

The instant invention in large part solves the problems of the prior and fulfills a long felt need by providing rapid access to favored television programming combined graphic and printed indicia.

The instant invention provides rapid access to favored television programming graphic and printed indicia with a novel arrangement of pages within a television programming schedule guide.

Also contemplated by the invention is a process for manufacturing a novel arrangement of pages within a television programming schedule guide which provides rapid access to favored television programming combined graphic and printed indicia.

The more important features of the invention have been broadly outlined above, in order that the detailed description that follows may be better understood; and in order that the present contribution to the art may be better appreciated. There are additional features of the invention that will be described hereinafter and which form the subject matter of the appended claims. Those of ordinary skill in the art will appreciate that the conception upon which this disclosure is based may readily be utilized as a basis for the designing of other structures, methods and systems for carrying out the several purposes of the instant invention. It is important, therefore, that the claims be regarded as including such equivalent constructions insofar as they do not depart from the spirit and scope of the instant invention.

Further, the purpose of the instant abstract is to enable the U.S. Patent and Trademark office and the public generally, and especially the scientists, engineers and practitioners in the art who are not familiar with patent or legal terms or phraseology, to determine quickly from a cursory inspection of it, the technical disclosure of the patent application. The abstract is neither intended to define the invention of the instant patent application, which is measured by the claims, nor is it intended in any manner to be limiting as to the scope of the instant invention.

In light of the foregoing, it is therefore an object of the instant invention to provide a new and improved television channel selection program guide which provides for rapid access to favored television programming information at a single glance, which has all of the advantages of the prior art and none of its disadvantages.

It is another object of the instant invention to provide a new and improved television channel selection program guide which can provide programming information characteristic of the entire program guide at a single glance, and which may be easily and efficiently manufactured and marketed.

It is another object of the instant invention to provide a new and improved television channel selection program guide directed to specific interests, which can be manufactured at low cost with regard to both labor and materials, and which accordingly can be sold at a low cost or given as a promotional advertisement gift to members of the consuming public, thus promoting commerce.

It is a further object of the instant invention to provide a television program guide directed to a special interest.

It is a further object of the instant invention to provide a television program guide specific to movies.

It is a further object of the instant invention to provide a television program guide specific to sports.

It is a further object of the instant invention to provide a television program guide specific to specials.

It is a further object of the instant invention to provide a television program guide specific to series.

It is a further object of the instant invention to provide a television program guide specific to news.

It is a further object of the instant invention to provide a television program guide specific to shopping, wherein by merely opening the front cover of the guide, the television viewer is presented with a view of at least a portion of more than one page of the guide, the wherein combined graphic and printed indicia on each portion optionally indicates the contents of that page.

It is a further object of the instant invention to provide a television program guide specific to movies including, but not necessarily limited to: action/adventure movies, children movies, comedy movies, drama movies, fantasy movies, horror movies, musical movies, romance movies, science fiction movies, western movies and other miscellaneous movies, wherein by merely opening the front cover of the guide, the television viewer is presented with a view of at least a portion of more than one page of the guide, optionally wherein the combined graphic and printed indicia on each portion indicates the contents of that page.

It is a further object of the instant invention to provide a television program guide specific to sports including, but not necessarily limited to: baseball, basketball, boxing, football, golf, hockey, racing, skiing, soccer, tennis, wrestling and other miscellaneous sports, wherein by merely opening the front cover of the guide, the television viewer is presented with a view of at least a portion of more than one page of the guide, wherein the combined graphic and printed indicia on each portion optionally indicates the contents of that page.

It is a further object of the instant invention to provide a television program guide specific to specials including, but not necessarily limited to: children specials, comedy specials, cultural arts specials, drama specials, educational specials, general interest specials, how-to specials, nature specials, music specials, religious specials, soap-opera specials and talk specials, wherein by merely opening the front cover of the guide, the television viewer is presented with a view of at least a portion of more than one page of the guide, wherein combined graphic and printed indicia on each portion optionally indicates the contents of that page.

It is a further object of the instant invention to provide a television program guide specific to series including, but not necessarily limited to: children series, comedy series, cultural arts series, drama series, educational series, general interest series, how-to series, nature series, music series, religious series, soap-opera series and talk series, wherein by merely opening the front cover of the guide, the television viewer is presented with a view of at least a portion of more than one page of the guide, optionally wherein combined graphic and printed indicia on each portion indicates the contents of that page.

It is a further object of the instant invention to provide a television program guide specific to news including, but not necessarily limited to: business news, current news, general interest news, sports news and weather news, wherein by merely opening the front cover of the guide, the television viewer is presented with a view of at least a portion of more than one page of the guide, wherein the wherein combined graphic and printed indicia on each portion optionally indicates the contents of that page.

It is a further object of the instant invention to provide a television program guide specific to shopping including, but not necessarily limited to: home shopping and product information, wherein by merely opening the front cover of the guide, the television viewer is presented with a view of at least a portion of more than one page of the guide, wherein the wherein combined graphic and printed indicia on each portion optionally indicates the contents of that page.

It is a further object of the instant invention to provide an improved television programming guide general to all interests of television viewing.

It is a further object of the instant invention to provide an improved television programming guide general to all interests of television viewing including: movies, sports, specials, series, news and shopping.

It is a further object of the instant invention to provide an improved television programming guide general to all interests of television viewing.

Other objects, features, and advantages of the instant invention, in its details of construction and arrangement of parts, will be seen from the above, from the following description of the preferred embodiment when considered in light of the drawings and the appended claims.

### BRIEF DESCRIPTION OF THE DRAWING

FIG. 1, shows the improved television program guide of the method of the invention.

### DETAILED DESCRIPTION OF THE INVENTION

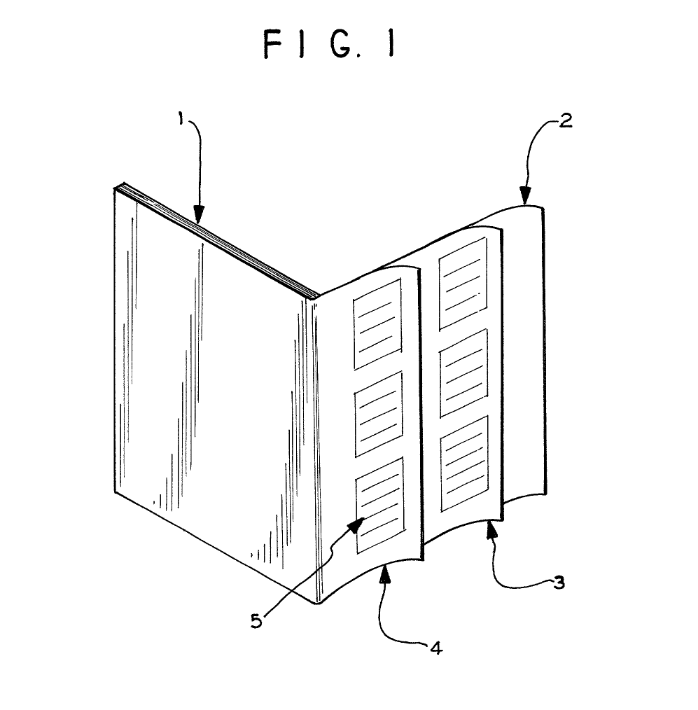

As shown in FIG. 1, the instant invention provides an improved television program guide which includes a front cover (1); a back cover (2); and, at least n substantially rectangular pages between the front cover and the back cover. The instant television program guide is further characterized by the following conditions: n is a finite integer; the first of the n pages is most proximate the front cover and the nth of the n pages (3) is more proximate the back cover than the first page; the lateral dimension of the nth page is larger than the lateral dimension of the (n-1)th page; and, an area on each of the (n-1)th (4) and nth (3) pages come into view when only the front cover (1) is opened. Combined graphic and printed indicia is depicted at (5).

The invention also provides a method for manufacturing an improved television program guide which includes a front cover; a back cover; and, at least n substantially rectangular pages between the front cover and the back cover; where the n is a finite integer; where the first of the n pages is most proximate the front cover and the nth of the n pages is more proximate the back cover than the first page; where the lateral dimension of the nth page is larger than the lateral dimension of the (n-1)th page; and, where the areas on the nth and the (n-1)th pages can be viewed when only the front cover is opened. The method includes the steps of providing a first sheet having a first lateral dimension and which is to form the front cover and the back cover; providing at least a second sheet having a second lateral dimension and which is to form the nth page; where the first lateral dimension is greater than the second lateral dimension; providing at least a third sheet having a third lateral dimension and which is to form the (n-1)th page; where the second lateral dimension is greater than the third lateral dimension; positioning the second sheet on top of the first sheet sufficient to cause the edge which is to be the edge of the back cover to be contiguous with the edge which is to be the edge of the nth page; positioning the third sheet on top of the second and first sheets sufficient to cause the edge which is to be the edge of the nth page to be contiguous with the edge which is to be the edge of the (n-1)th page; folding the first, second and third sheets to form at least the front cover, the (n-1)th page; the nth page; and, the back cover, sufficient to cause the back cover to have a greater lateral dimension than the front cover; and, providing combined graphic and printed indicia on each of the areas.

The printed indicia preferably includes combined graphic and printed indica characteristic of movies, sports, specials, series, news and shopping. Indicia characterizing movies, is typically selected from among action/adventure movies, children movies, comedy movies, drama movies, fantasy movies. horror movies, musical movies, romance movies, science fiction movies, western movies and other miscellaneous movies. Indicia characterizing sports is typically selected from among baseball, basketball, boxing, football, golf, hockey, racing, skiing, soccer, tennis, wrestling and other miscellaneous sports. Indicia characterizing specials typically is selected from among children specials, comedy specials, cultural arts specials, drama specials, educational specials, general interest specials, how-to specials, nature specials, music specials, religious specials, soap-opera specials and talk specials. Indicia characterizing series is typically selected from among children series, comedy series, cultural arts series, drama series, educational series, general interest series, how-to series, nature series, music series, religious series, soap-opera series and talk series. Indicia characterizing news is typically selected from among business news, current news, general interest news, sports news and weather news. Indicia characterizing shopping is typically selected from among home shopping and product information.

Although the invention has been described with reference to certain preferred embodiments, it will be appreciated that many variations and modifications may be made within the scope of the broad principles of the invention. Hence, it is intended that the preferred embodiments and all of such variations and modifications be included within the scope and spirit of the invention, as defined by the following claims.

I claim:

1. An improved television program guide comprising:
a front cover;
a back cover; and,
at least n substantially rectangular pages between said front cover and said back cover;
wherein n is a finite integer;
wherein said first of said n pages is most proximate said front cover and said nth of said n pages is more proximate said back cover than said first page;
wherein said lateral dimension of said nth page is larger than said lateral dimension of said (n-1)th page; and,
wherein an area on said (n-1)th and nth pages come into view when only said front cover is opened.

2. The improved television program guide of claim 1, wherein said areas comprises indicia selected from the group consisting of printed indicia, graphic indicia and combinations thereof.

3. The improved television program guide of claim 2, wherein said indicia on said area indicates at least a portion of the contents of its page.

4. The improved television program guide of claim 3, wherein said indicia is characterized by programming selected from the group consisting of: movies, sports, specials, series, news and shopping;

5. The improved television program guide of claim 4, wherein said movies are selected from the group consisting of: action/adventure, children, comedy, drama, fantasy, horror, musical, romance, science fiction, western and other; said sports are selected from the group consisting of:
baseball, basketball, boxing, football, golf, hockey, racing, skiing, soccer, tennis, wrestling and other; said specials are selected from the group consisting of children, comedy, cultural arts, drama, educational, general interest, how-to, nature, music, religious, soap-opera and talk; said series are selected from the group consisting of children, comedy, cultural arts, drama, educational, general interest, how-to, nature, music, religious, soap-opera and talk; said news is selected from the group consisting business, current, general interest, sports and weather; and, said shopping is selected from the group consisting of home shopping and product information.

6. An improved television program guide comprising:
a front cover;
a back cover; and,
at least n substantially rectangular pages between said front cover and said back cover;
wherein n is a finite integer;
wherein said first of said n pages is most proximate said front cover and said nth of said n pages is more proximate said back cover than said first page;
wherein the lateral dimension of the nth page is larger than the lateral dimension of the (n-1)th page;
wherein areas on said (n-1)th and nth pages come into view when only said front cover is opened page;
wherein each of said areas comprises indicia selected from the group consisting of printed indicia, graphic indicia and combinations thereof;
wherein said indicia optionally indicates the contents of its respective page;
wherein said indicia is characterized by programming selected from the group consisting of movies, sports, specials, series, news and shopping; and,
wherein said movies are selected from the group consisting of: action/adventure, children, comedy, drama, fantasy, horror, musical, romance, science fiction, western and other; said sports are selected from the group consisting of: baseball, basketball, boxing, football, golf, hockey, racing, skiing, soccer, tennis, wrestling and other; said specials are selected from the group consisting of children, comedy, cultural arts, drama, educational, general interest, how-to, nature, music, religious, soap-opera and talk; said series are selected from the group consisting of children, comedy, cultural arts, drama, educational, general interest, how-to, nature, music, religious, soap-opera and talk; said news is selected from the group consisting business, current, general interest, sports and weather; and, said shopping is selected from the group consisting of home shopping and product information.

7. A method for manufacturing an improved television program guide which includes a front cover; a back cover; and at least n substantially rectangular pages between said front cover and said back cover; wherein n is a finite integer; wherein said first of said n pages is most proximate said front cover and said nth of said n pages is more proximate said back cover than said first page; wherein the lateral dimension of the nth page is larger than the lateral dimension of the (n-1)th page; and, wherein areas on said nth and said (n-1)th pages can be viewed when only said front cover is opened, comprising:
providing a first sheet having a first lateral dimension and which is to form said front cover and said back cover;
providing at least a second sheet having a second lateral dimension and which is to form said nth page; wherein said first lateral dimension is greater than said second lateral dimension;
providing at least a third sheet having a third lateral dimension and which is to form said (n-1)th page; wherein said second lateral dimension is greater than said third lateral dimension;
positioning said second sheet on top of said first sheet sufficient to cause the edge which is to be the edge of said back cover to be contiguous with the edge which is to be the edge of said nth page;
positioning said third sheet on top of said second and first sheets sufficient to cause the edge which is to be the edge of said nth page to be contiguous with the edge which is to be the edge of said (n-1)th page;
folding said first, second and third sheets to form at least said front cover, said (n-1)th page; said nth page; and, said back cover, sufficient to cause said back cover to have a greater lateral dimension than said front cover; and,
providing combined graphic and printed indicia on each of said areas.

8. The method of claim 7, wherein said indicaia is combined graphic and printed indicia, characterized by a plurality of television viewer interests selected from the group consisting of: movies, wherein the movies are selected from the group consisting of: action/adventure, children, comedy, drama, fantasy, horror, musical, romance, science fiction, western and other; sports, wherein the sports are selected from the group consisting of: baseball, basketball, boxing, football, golf, hockey, racing, skiing, soccer, tennis, wrestling and other; specials, wherein the specials are selected from the group consisting of children, comedy, cultural arts, drama, educational, general interest, how-to, nature, music, religious, soap-opera and talk; series, wherein the series selected from the group consisting of children, comedy, cultural arts, drama, educational, general interest, how-to, nature, music, religious, soap-opera and talk; news, wherein the news is selected from the group consisting business, current, general interest, sports and weather; and shopping. The method includes a second step of manipulating means to find and copy all references to a single desired interest; a third step of manipulating the means to create a file separate from the data base; a fourth step of manipulating the means to deposit the all references into the file in a desired preselected order; a fifth step of providing means for printing; a sixth step of manipulating the means for printing at least one page of the file; and, a final step of incorporating the at least one page into a television program guide.
